(19) United States
(12) Patent Application Publication
(10) Pub. No.: US 2010/0308749 A1
(43) Pub. Date: Dec. 9, 2010

(54) AC Power Line Controlled Light Emitting Device Dimming Circuit and Method Thereof

(75) Inventor: Jing-Meng Liu, Zhubei City (TW)

Correspondence Address: TUNG & ASSOCIATES / RANDY W. TUNG, ESQ., 838 W. LONG LAKE RD., SUITE 120, BLOOMFIELD HILLS, MI, 48302, US

(73) Assignee: Richtek Technology Corporation

(21) Appl. No.: 12/788,757

(22) Filed: May 27, 2010

Related U.S. Application Data
(60) Provisional application No. 61/183,905, filed on Jun. 3, 2009.
(60) Provisional application No. 61/218,482, filed on Jun. 19, 2009.

(51) Int. Cl. H05B 37/02

(52) U.S. Cl. 315/307

(57) ABSTRACT

The present invention discloses an AC power line controlled light emitting device dimming circuit and a method thereof. The AC power line controlled light emitting device dimming circuit includes: a light emitting device driver circuit for controlling current through a light emitting device, wherein the light emitting device is current-controlled; and a level adjustment circuit for detecting power-OFF of an AC power switch and generating a corresponding level adjustment signal which is transmitted to the light emitting device driver circuit to control the current through the light emitting device accordingly.

### CROSS REFERENCE

The present invention claims priority to U.S. provisional application No. 61/183,905, filed on Jun. 3, 2009, and U.S. provisional application No. 61/218,482, filed on Jun. 19, 2009.

### BACKGROUND OF THE INVENTION

1. Field of Invention

The present invention relates to an AC power line controlled light emitting device dimming circuit and a method thereof.

2. Description of Related Art

One form of light emitting device which is commonly used nowadays is light emitting diode (LED). More and more indoor and outdoor illumination facilities are using LEDs to replace fluorescent lamps and incandescent lamps. However, because an LED is current-controlled, but a fluorescent or incandescent lamp is voltage-controlled, in order to replace an LED for a fluorescent or incandescent lamp without changing the infrastructure of a building, the control circuit for the LED must be specially designed. In addition, in some applications, it is required to control the brightness of a lamp so that it can be adjusted to multiple different levels. In this case, the LED lamp should be able to provide such level adjustment function, i.e., dimming function, and it is preferred that the infrastructure of the building needs not be changed.

In view of the foregoing, the present invent provides an AC power line controlled light emitting device dimming circuit, and a method thereof, to meet the above requirements.

### SUMMARY OF THE INVENTION

An objective of the present invention is to provide an AC power line controlled light emitting device dimming circuit, so that a user can adjust the brightness of a light emitting device by operating an AC power switch.

Another objective of the present invention is to provide a method of dimming an AC power line controlled light emitting device.

To achieve the foregoing objectives, in one perspective of the present invention, it provides an AC power line controlled light emitting device dimming circuit comprising: a light emitting device driver circuit for controlling current through a light emitting device, wherein the light emitting device is current-controlled; and a level adjustment circuit for detecting power-off of an AC power switch and generating a corresponding level adjustment signal which is transmitted to the light emitting device driver circuit to control the current through the light emitting device accordingly.

The level adjustment circuit for example can be a signal generator, a reference signal generator, or a pulse width modulation (PWM) dimming signal generator. The level adjustment circuit and the light emitting device driver circuit can be integrated in the same integrated circuit (IC), or can be two separated chips.

In one preferable embodiment, the light emitting device and the light emitting device driver circuit can be coupled to different capacitors respectively.

In another perspective of the present invention, it provides a method of dimming an AC power line controlled light emitting device, comprising: providing a light emitting device, wherein the light emitting device is current-controlled;

detecting power-off of an AC power switch and generating a corresponding level adjustment signal; and controlling a current through the light emitting device according to the level adjustment signal.

The objectives, technical details, features, and effects of the present invention will be better understood with regard to the detailed description of the embodiments below, with reference to the drawings.

### BRIEF DESCRIPTION OF THE DRAWINGS

FIG. 1A shows a basic concept of the present invention, in which a user can adjust the brightness of an LED by an AC power switch.

FIGS. 1B-1D show three embodiments of the level adjustment circuit.

FIG. 2 shows one embodiment according to the structure scheme shown in FIG. 1B.

FIGS. 3-8 show several variations according to the structure scheme shown in FIG. 1B.

FIG. 9 shows an example that, by providing a proper capacitor, the LED driver circuit 20 can operate in a period after the AC power switch is turned off.

FIG. 10 shows an example that the signal generator 11 can detect power-off of the AC power switch from other locations of the circuit, not directly the AC power switch.

FIG. 11A shows an embodiment to adjust the brightness of the LED according to the power-off times of the AC power switch.

FIG. 11B shows another embodiment to adjust the brightness of the LED according to the power-off times of the AC power switch.

FIG. 12 shows another embodiment with more circuit details, also for adjusting the brightness of the LED according to the power-off times of the AC power switch.

FIG. 13 shows the waveforms of the AC input, the pulse generated by the power-off detection circuit 11a, the reference signal Vref, and LED current I(LED).

FIG. 14 shows, by way of example, several patterns for adjusting the LED brightness.

FIG. 15 shows an example that the reference signal generator 13 and the LED driver circuit 20 are separated to two chips.

FIG. 16 shows an example of the reference signal generator 13.

FIG. 17 shows two examples to adjust the LED brightness by the reference signal Vref.

FIG. 18 shows an embodiment in which the PWM dimming signal generator 15 and the LED driver circuit 20 are separated to two chips.

FIG. 19 shows an embodiment of the PWM dimming signal generator 15.

FIG. 20 shows an embodiment of the duty ratio controller 207.

FIGS. 21-22 show two other embodiments of the duty ratio controller 207.

FIGS. 23A-23C show that the comparator 2071 may be replaced by a hysteresis amplifier (Smith trigger), or inverters connected in series.

### DESCRIPTION OF THE PREFERRED EMBODIMENTS

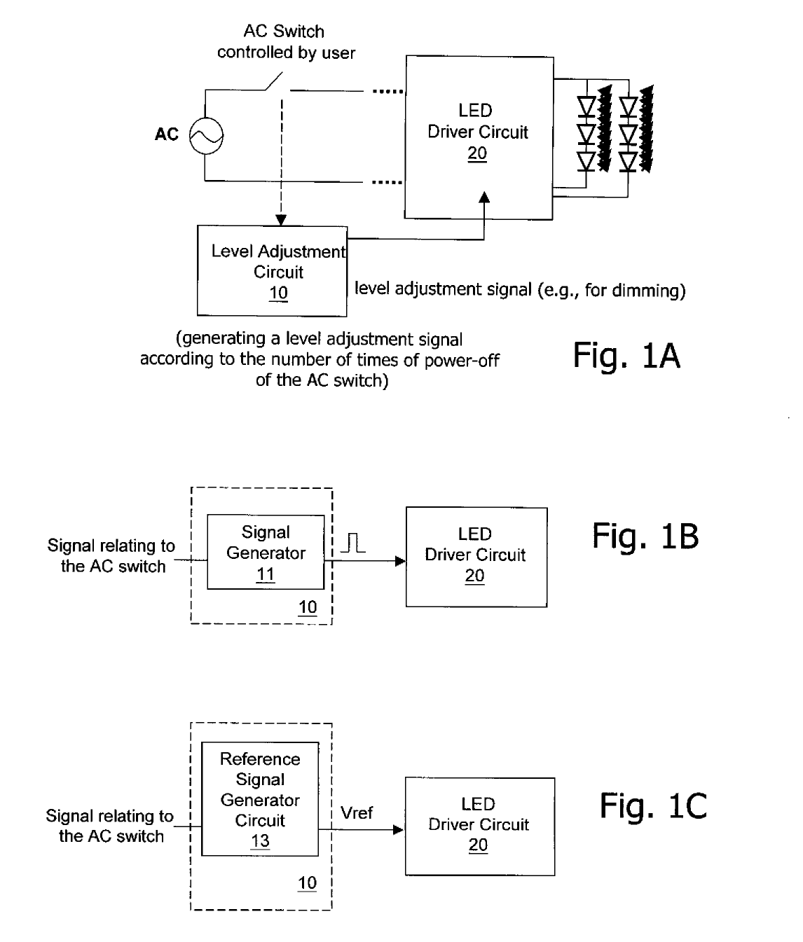

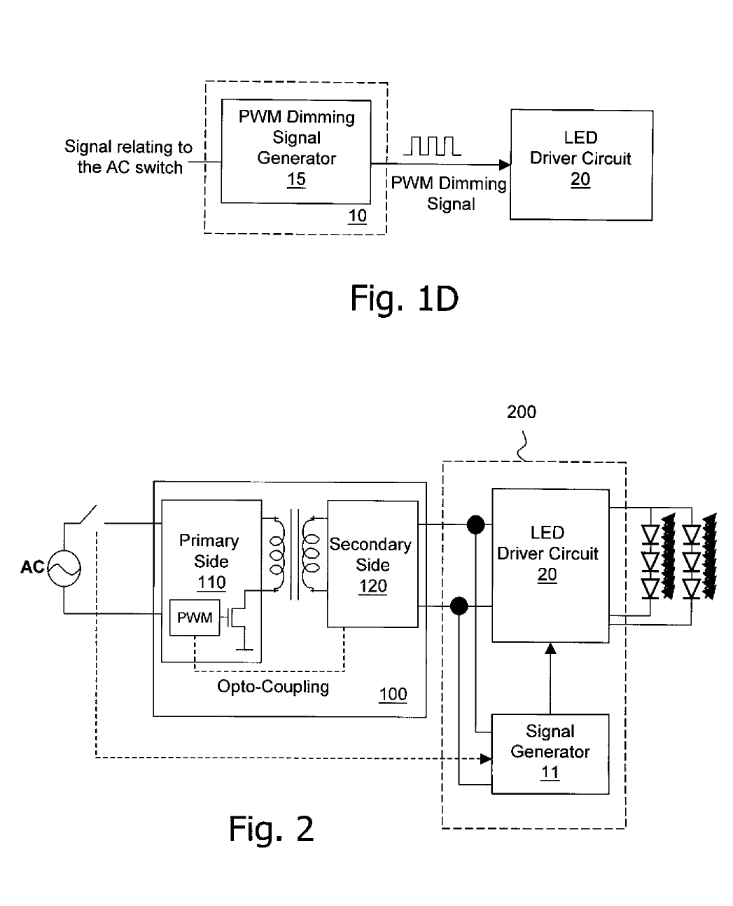

FIG. 1A shows a basic concept of the present invention. A user can adjust the brightness of an LED lamp by operating an AC power switch, such as a switch located on a wall. A level adjustment circuit 10 generates a level adjustment signal as it detects power-off of the AC power switch, and it transmits the level adjustment signal to an LED driver circuit 20 to control the brightness of the LED correspondingly. For instance, when the user turns on the AC power switch, the LEDs illuminate a first-level brightness; when the user turns off the AC power switch once and turns it on, the LEDs illuminate a second-level brightness; when the user turns off the AC power switch twice and turns it on, the LEDs illuminates a third-level brightness; and so forth. The LED driver circuit 20 can directly or indirectly receive power from the AC power supply, as shown by the dashed line.

Referring to FIGS. 1B-1D, the level adjustment circuit 10 can be embodied by various ways. In the first structure scheme (FIG. 1B), the level adjustment circuit 10 includes a signal generator 11 which generates a pulse each time the AC power switch is power-off. The LED driver circuit 20 includes a circuit for controlling the brightness of the LEDs according to the number of the pulses. In the second structure scheme (FIG. 1C), the level adjustment circuit 10 includes a reference signal generator 13 which generates a reference signal Vref according to the power-off times of the AC power switch, and the LED driver circuit 20 controls the brightness of the LEDs according to this reference signal Vref. In the third structure scheme (FIG. 1D), the level adjustment circuit 10 includes a pulse width modulation (PWM) dimming signal generator 15 which generates a PWM dimming signal according to the power-off times of the AC power switch; the LED driver circuit 20 controls the brightness of the LEDs according to the PWM dimming signal. The details to embody above the structure schemes will be discussed in detail in the following description.

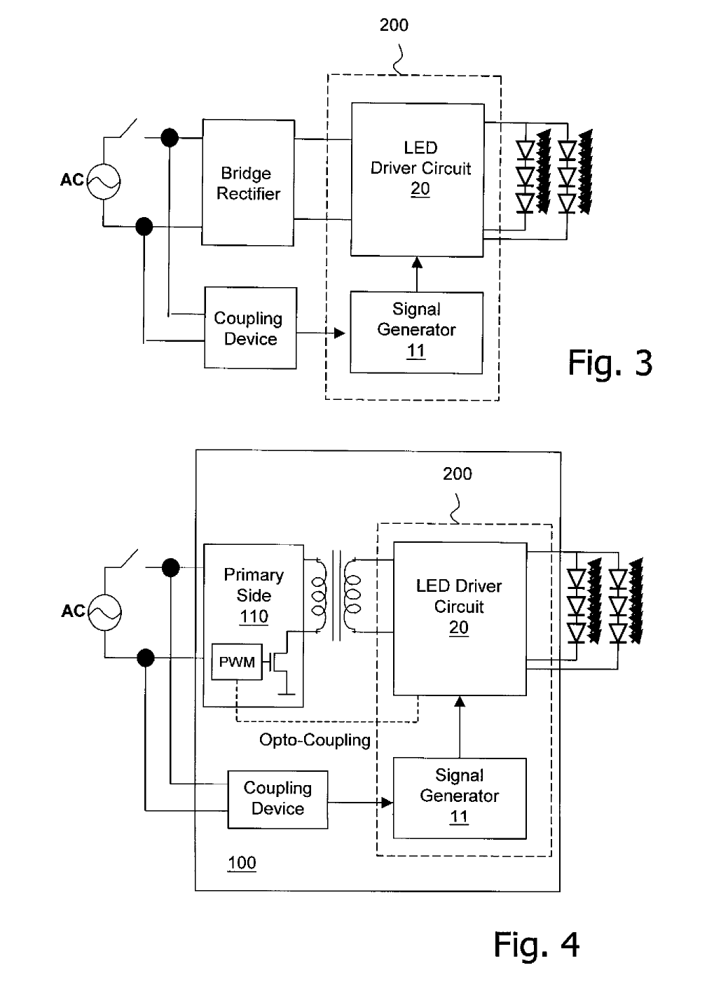

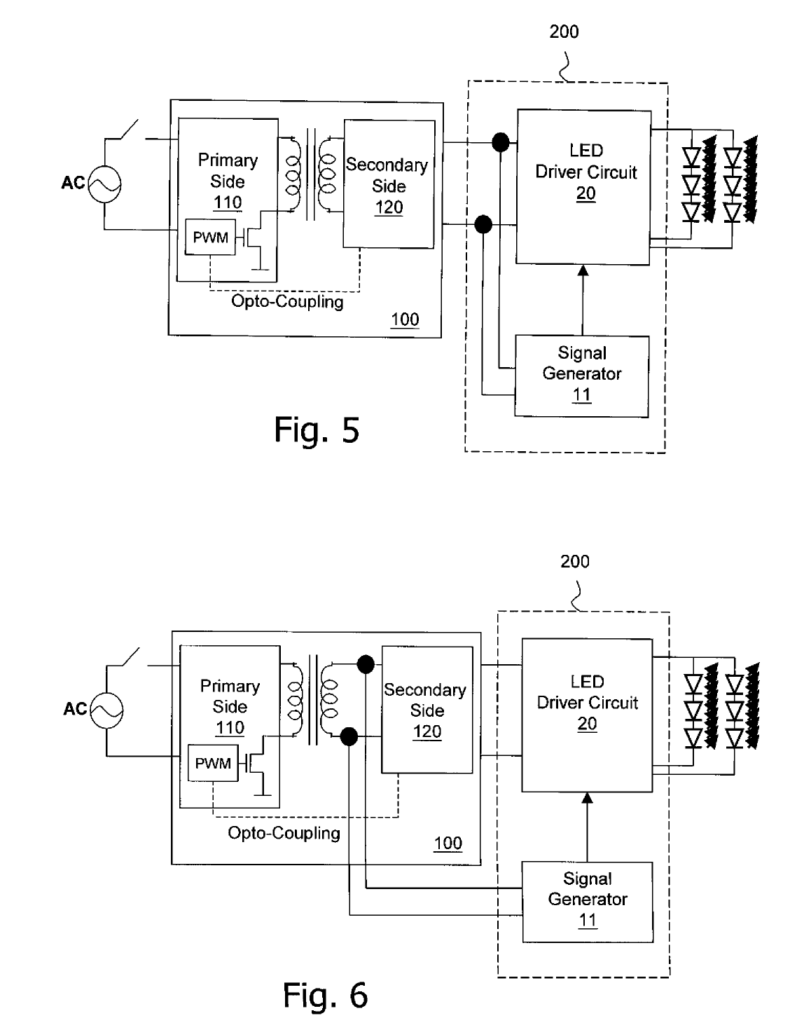

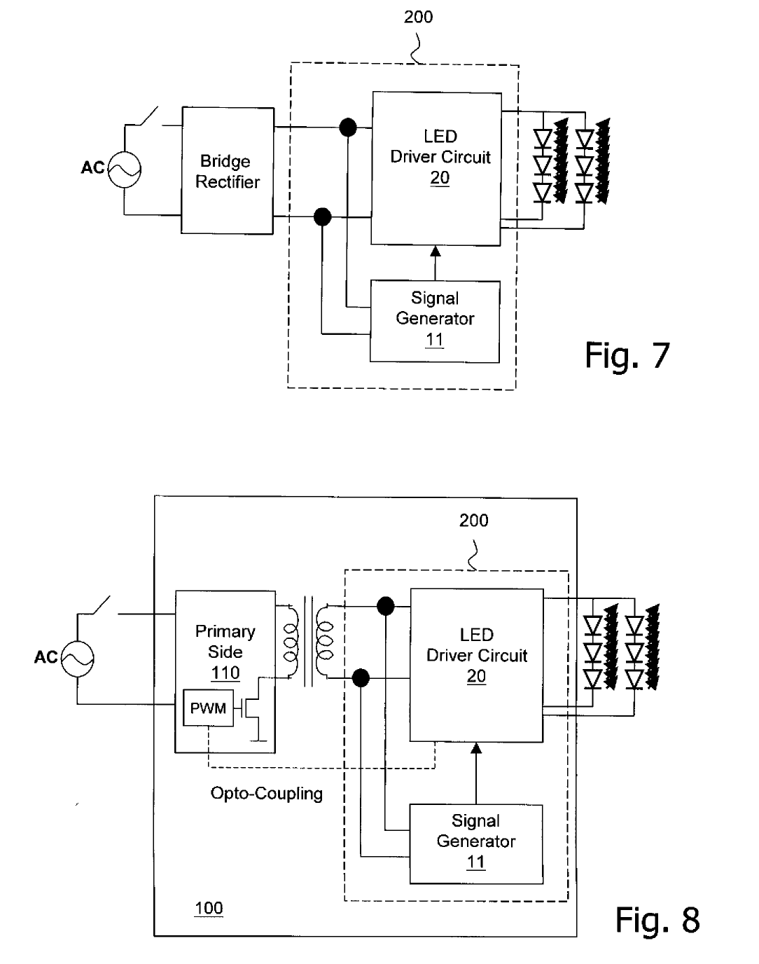

Please refer to FIG. 2, which shows one embodiment according to the first structure scheme. In this embodiment, an AC to DC converter 100 (including a primary side circuit 110 and a secondary side circuit 120) converts an AC voltage to a DC voltage which is supplied to a signal generator 11 and an LED driver circuit 20; the signal generator 11 and the LED driver circuit 20 may be integrated in one IC chip 200 (hereinafter referred to as LED control chip 200). The embodiment shown in FIG. 2 is not the only way to embody the first structure scheme; for example, the LED control chip 200 can receive power directly, without the AC to DC converter 100 (e.g., it can receive power rectified by a bridge rectifier). Or, the LED control chip 200 may replace the secondary side circuit 120 to become a part of the AC to DC converter 100. In addition, the power of the signal generator 11 is not required to come from the same source as that of the LED driver circuit 20; it can obtain power from any other locations capable of providing power. The signal generator 11 is not required to detect the AC power off events directly from AC power switch; it can detect the AC power off events from every node-voltage or any path-current reflecting the existence of AC power after the power switch. Some examples of such variations and modifications are shown in FIGS. 3-8. Certainly, the signal generator 11 and the LED driver circuit are not required to be integrated in one IC chip; they can be separated to two IC chips.

Notably, in each of the foregoing embodiments, since a subsequent circuit (i.e., a circuit which receives power through the AC power switch) will also shut down when the AC power switch is turned off, it is not necessary for the signal generator 11 to receive power-off information directly from the AC power switch; the signal generator 11 can indirectly receive the power-off information of the AC power switch from the power-off of the subsequent circuit, or by other ways.

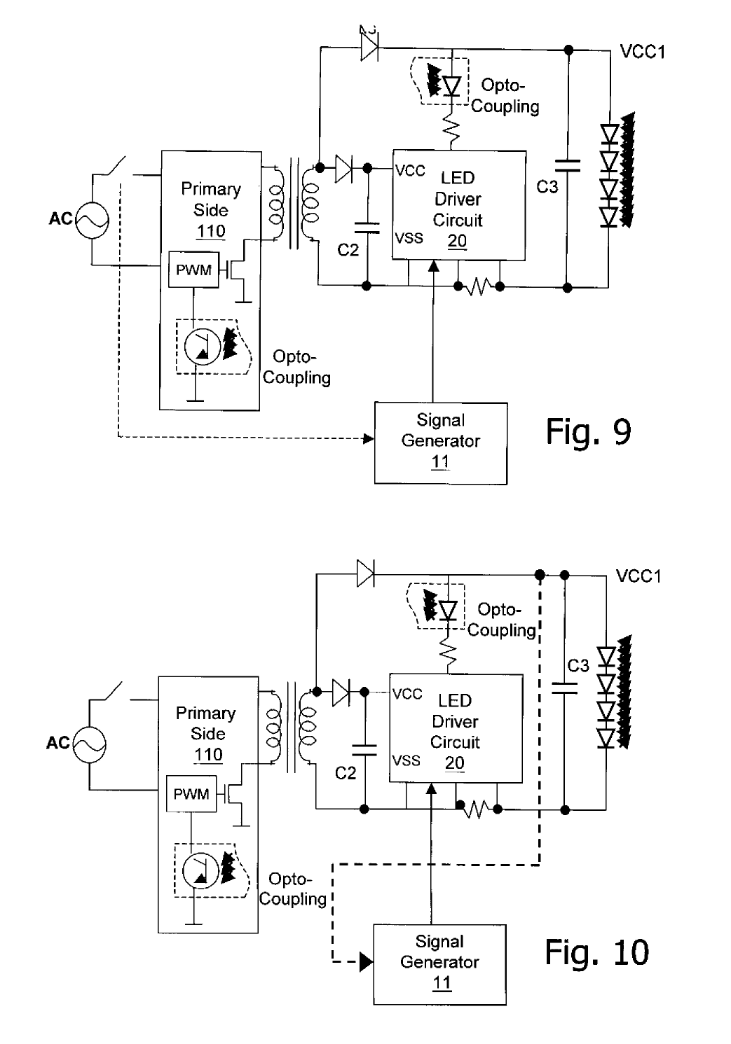

In the present invention, because the level adjustment signal is generated in response to the power-off of the AC power switch, the LED driver circuit 20 should be able to operate in a period after the AC power switch is turned off. There are many ways to achieve this objective; for instance, as shown in FIG. 9 under the structure scheme of FIGS. 2 to 8, this objective can be achieved by providing a capacitor C2. Since the LEDs require larger current, another capacitor C3 for the LEDs should be provided, so that the LEDs and the LED driver circuit 20 do not share a common capacitor. When the AC power switch is turned off, the capacitor C3 discharges quickly, but the charges in the capacitor C2 are retained for a longer period because the LED driver circuit 20 consumes less power. Therefore, the LED driver circuit 20 can operate in this period, to adjust the brightness of the LED to a desired level. If the power-off period of the LED is so long that the capacitor C2 discharges almost completely, this means that the user intends to turn off the lamp, not to control its brightness; hence, it is not required to memorize the number of the power-off times, and the LED driver circuit 20 is not required to perform any operation. In this case, the circuit may be reset to its default value, such that the brightness of the LEDs is reset to the default brightness at next power-on. As can be understood from the foregoing description, in addition to supplying power to the LED driver circuit 20, the capacitor C2 also provides a function as a time-out timer, to reset the brightness of the LEDs to the default value when the power-off period of the AC power switch is longer than a predetermined period. Certainly, the time-out control can be performed by any other type of time-out timer, provided in the circuit in addition to the capacitor C2.

Due to the difference between the charge storage time of the capacitors C2 and C3, the signal generator 11 can obtain the power-off information of by detecting the voltage across the capacitor C3, as shown in FIG. 10. In addition to this example, there are many other ways to obtain the power-off information of the AC power switch, such as by detecting a certain change pattern of the LED current.

The foregoing description illustrates an example to retain power under the structure scheme that the LED control chip 200 is a part of the AC to DC converter 100. Under other structure schemes, the power required by the LED driver circuit 20 can also be retained by providing a proper capacitor. The power source of the signal generator 11 is not shown in FIGS. 9 and 10; it can come from the capacitor C2 as well, or from other places of the circuit. As discussed in the following description, in one preferable embodiment, the signal generator 11 only generates one single pulse at the power-off of the AC power switch, so it only requires very little power.

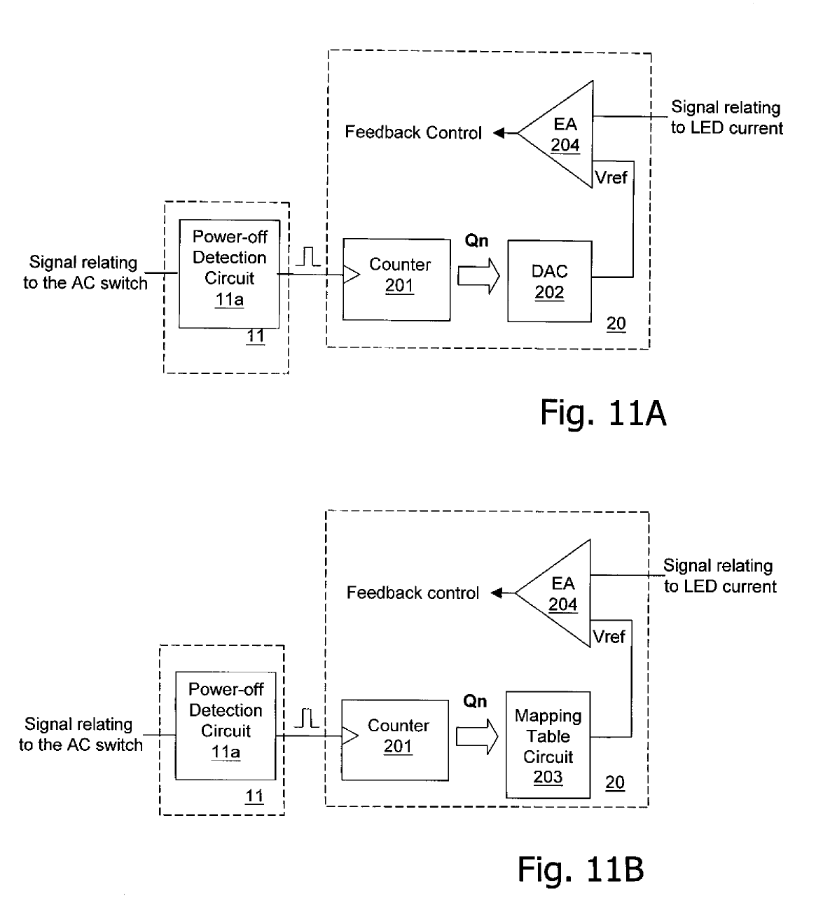

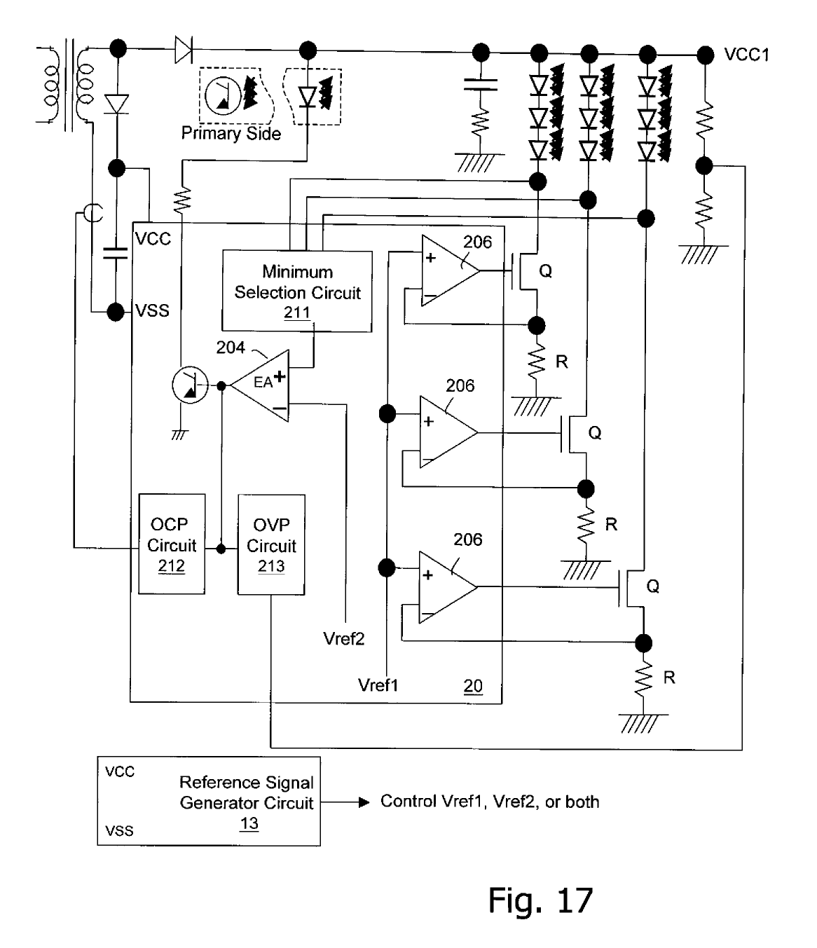

FIG. 11A shows an embodiment to adjust the brightness of the LED by the power-off times of the AC power switch. In this embodiment, the signal generator can be a power-off detection circuit 11a. The power-off detection circuit detects the power-off of the AC power switch (as mentioned earlier, the power-off information can be obtained directly or indirectly), and generates one pulse in response to each detected power-off of the AC power switch. The LED driver circuit 20 includes a counter 201 for counting the number of the pulses generated by the power-off detection circuit 11a. The count number Qn for example can be converted to an analog signal, the reference signal Vref, by a digital to analog conversion device (DAC) 202. An error amplifier (EA) 204 compares a signal relating to the LED current with the reference signal Vref, and provides an output for feedback control, such that the signal relating to the LED current is balanced at the level of the reference signal Vref, that is, the LED current (or LED brightness) is controlled at a desired level. (For better illustrating the critical devices, other circuits in the LED driver circuit 20 are omitted and not shown in FIG. 11A. An example of the details of the LED driver circuit 20 is shown in FIG. 17.)

The DAC in the embodiment shown in FIG. 11A may be regarded as a digital to analog conversion device in a broad sense, that is, when different count numbers Qn are converted to different analog reference signals, the ratio or relationship among the count numbers are not required to be retained in the converted analog signals. For instance, when the count numbers 1, 2, 3 and 4 are converted to reference signals Vref1, Vref2, Vref3 and Vref4, the ratio among the reference signals Vref1, Vref2, Vref3 and Vref4 does not have to be 1:2:3:4, but can be, e.g., 1:2:4:8, 1:3:6:10, or other ratios. Since human eyes do not perceive small changes in certain brightness range, the level adjustment scale within such range can be enlarged. Or, as shown in FIG. 11B, a mapping table circuit 203 can be employed for digital to analog conversion (a mapping table circuit is also named a digital to analog decoder). As the mapping table circuit 203 converts the count numbers 1, 2, 3 and 4 to reference signals Vref1, Vref2, Vref3 and Vref4, the levels of the reference signals Vref1, Vref2, Vref3 and Vref4 do not have to be in upward sequential order; for example, they can be in reverse order, such as 7:5:3:1, or not in any order, such as 1:4:2:3. The mapping table circuit 203 can also be regarded as a digital to analog conversion device in a broad sense.

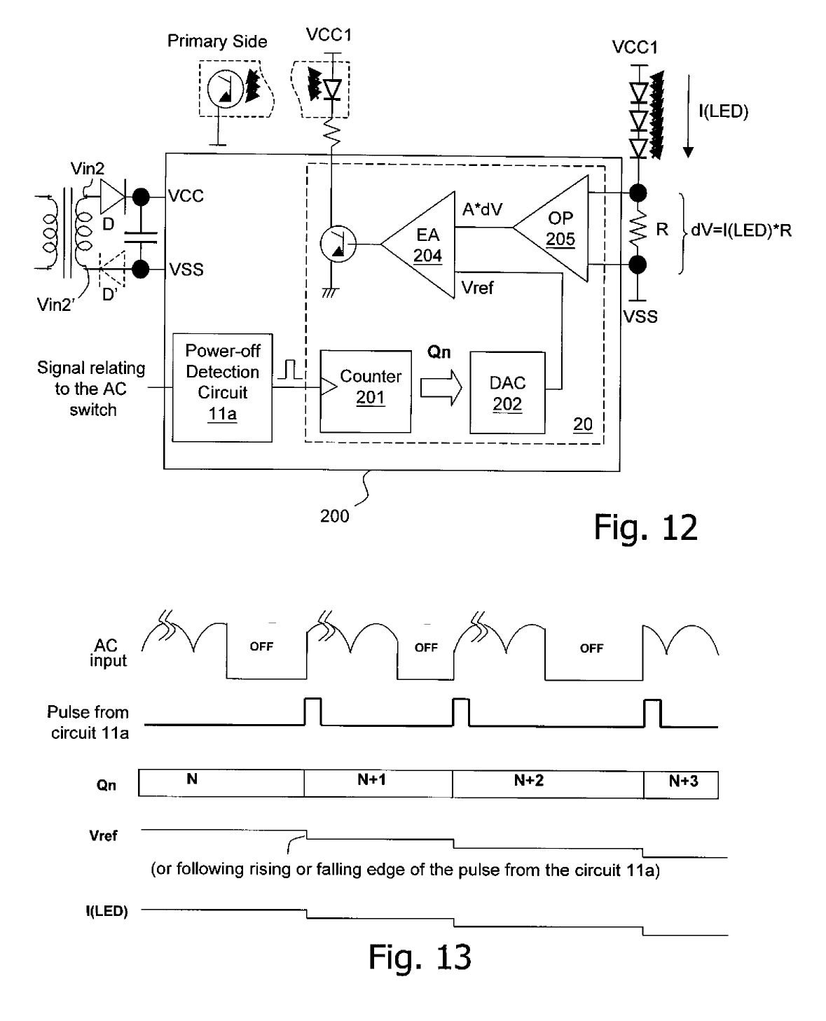

FIG. 12 shows how to control the brightness of the LEDs in more detail. In this embodiment, the LED control chip 200 is apart of the AC to DC converter 100. A resistor R is connected in series to a lower side of the LEDs, wherein the voltage dV across the resistor is a signal relating to the LED current I (LED), since dV=I(LED)*R. An operational amplifier 205 amplifies the voltage dV by A times, wherein A can be any real number. An error amplifier 204 compares the signal A*dV with the reference signal Vref, and transmits the result by opto-coupling to the primary side circuit 110 (not shown in FIG. 12, please refer to FIG. 9 for details). According to the feedback signal, the primary side circuit 110 controls a power switch therein to adjust the voltage VCC1, so that the LED current I(LED) is adjusted to a desired level.

In FIG. 12, the power-off detection circuit 11a detects the power-off of the AC power switch by, for example but not limited to, an AC signal or a rectified AC signal, or by other ways. For instance, assuming that the minimum voltage across the resistor R is dVo (minimum dV=dVo) when the AC power switch is turned on, the power-off detection circuit 11a can determine whether the AC power switch is turned off by detecting if dV is lower than dVo. Or, as shown in the drawing, the power-off detection circuit 11a can detect whether the level of the voltage Vin2 keeps lower than VCG for a time period. Or, as shown in a dashed line in the drawing, if the diode D is replaced by a diode D′, the power-off detection circuit 11a can detect whether the level of the voltage Vin2′ keeps higher than VSS for a time period.

FIG. 13 shows the relationships among the signal waveforms. The counter 201 counts the power-off times of the AC power switch (i.e., the number of pulses generated by the power-off detection circuit 11a), and the reference signal Vref is changed accordingly, so that the LED current I(LED) is also changed accordingly. The changes of the number counted by the counter 201 and the reference signal Vref follow the rising edge of the AC power switch (start point of on-period) in the shown example, but they can follow the falling edge of the AC power switch (start point of off-period), or a rising or falling edge of the pulse generated by the power-off detection circuit 11a.

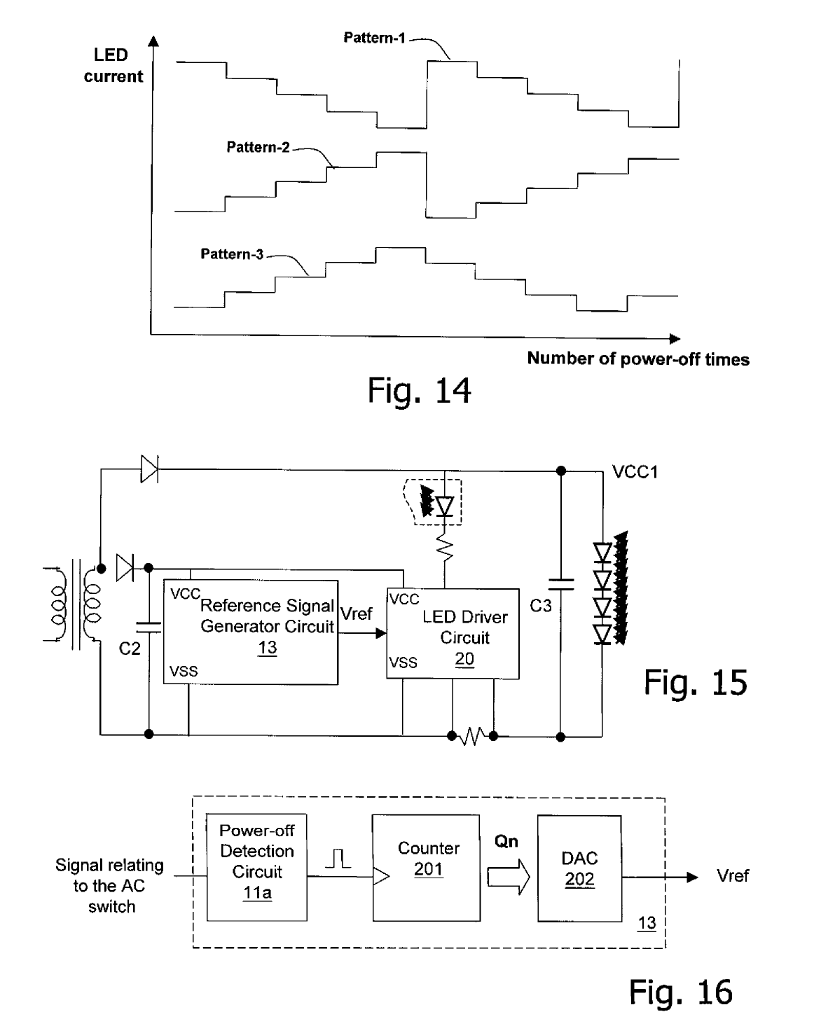

FIG. 14 shows several examples of patterns for adjusting the LED current (i.e., the LED brightness). For example, it can start from a default highest value and decrease in decrement (Pattern-1); start from a default lowest value and increase in increment (Pattern-2); or increase in increment and then decrease in decrement. Certainly there can be other arrangements.

Now we will describe the second structure scheme of the present invention. Referring to FIG. 1C, the level adjustment circuit 10 includes a reference signal generator 13 which generates a reference signal Vref in response to the power-off times of the AC power switch, and the LED driver circuit 20 adjusts the LED brightness according to this reference signal Vref. In this structure scheme, the LED driver circuit 20 can be a currently existing LED driver circuit, while it only requires coupling the reference level in the driver circuit for controlling the LED current (i.e., LED brightness) to the output of the reference signal generator 13. The reference signal generator 13 and the LED driver circuit 20 can be integrated into one integrated circuit, or separated to two chips. For details of the latter case, please refer to FIG. 15. Of course it is not the only way to directly use the generated Vref as the reference voltage of LED driver circuit 20 for regulating LED current. The generated Vref can also be used either as an analog dimming signal or to produce an analog dimming signal, which is coupled to an analog dimming control pin of the LED driver circuit 20, to adjust LED current.

Referring to FIG. 16 for an internal circuit structure of the reference signal generator 13, it includes: a power-off detection circuit 11a, a counter 201, and a DAC 202 (in broad sense, i.e., it can be the mapping table circuit 203). In this embodiment, the reference signal generator 13 operates in a way similar to that shown in FIG. 10. The power-off detection circuit 11a generates a pulse in response to each detected power-off of the AC power switch. The counter 201 counts the number of the pulses and generates the count number Qn. The DAC 202 (or mapping table circuit 203) converts the count number to the reference signal Vref.

There are various ways to adjust the LED current by the reference signal Vref, depending on the circuit structure of the LED driver circuit 20. One embodiment is shown in FIGS. 11 and 12, wherein the error amplifier 204 receives the reference signal Vref and feedback controls the voltage VCC1, so as to control the LED current. Yet, there are other ways to adjust the LED current by the reference signal Vref, not limited to this embodiment. Please refer to FIG. 17, which shows the circuit structure of an LED driver circuit 20 which controls multiple LED channels. In this structure scheme, a current source is formed by an error amplifier 206, a transistor Q, and a resistor R, wherein the error amplifier 206 compares the voltage across the resistor R with a reference signal Vref1 to determine the current through the corresponding LED channel. A minimum selection circuit 211 selects a lowest voltage among the LED channels; the error amplifier 204 compares the lowest voltage with the reference signal Vref2 to generate a feedback signal, which is sent to the primary side circuit for controlling the output voltage VCC1 of the secondary circuit. As understood from the foregoing, by changing the level of the reference signal Vref1, the LED current can be adjusted directly; by changing the level of the reference signal Vref2, the regulated level of the voltage VCC1 can be adjusted; as such, a user can adjust the current matching among multiple LED channels and the power utilization efficiency of the entire circuit to the optimized balance as he desires. In other words, the output of the reference signal generator 13 can be provided as the reference signal Vref1 or Vref2, or both, for LED brightness control. In the LED driver circuit 20, an over current protection circuit 212 and an over voltage protection circuit 213 may be provided, to prevent the circuit from being damaged because of short circuit at the output terminal or other reasons.

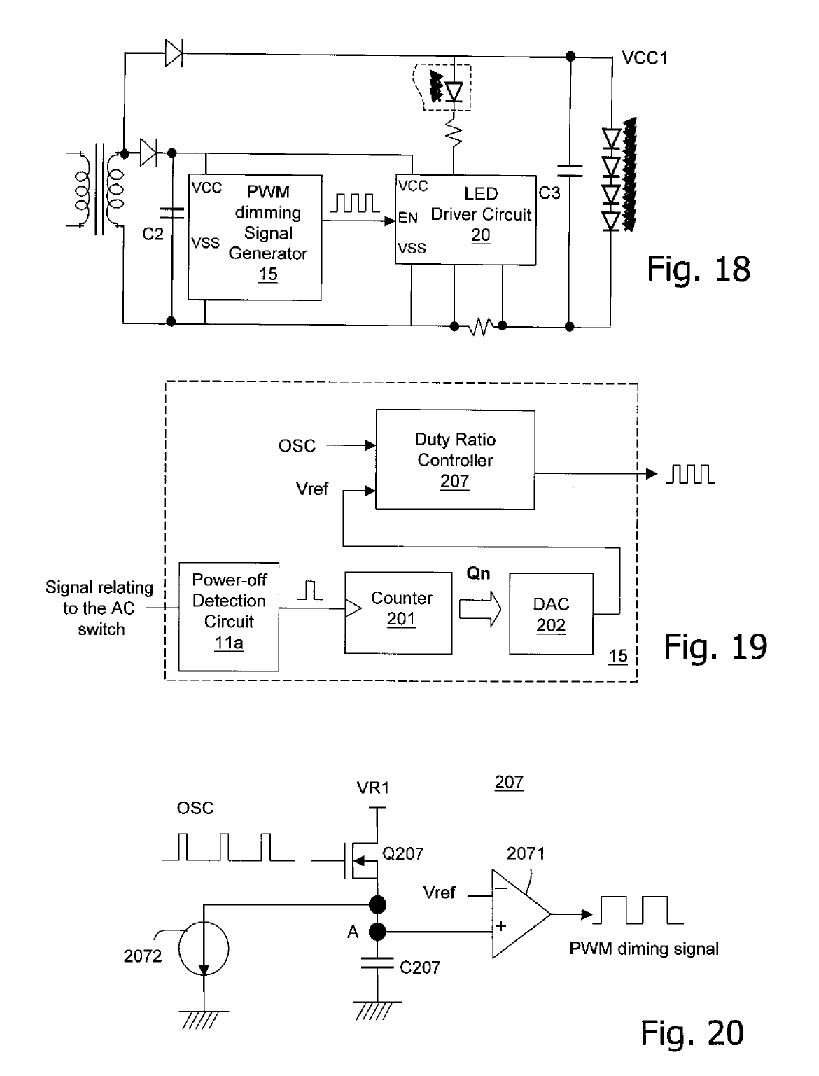

Now we will describe the third structure scheme of the present invention. As shown in FIG. 1D, the level adjustment circuit 10 includes a PWM dimming signal generator 15 which generates a PWM dimming signal in response to the power-off times of the AC power switch, and the LED driver circuit 20 adjusts the brightness of the LED according to the PWM dimming signal. In this structure scheme, as one example shown in FIG. 18, the PWM dimming signal generator 15 and the LED driver circuit 20 can be separated to two chips, wherein the LED driver circuit 20 includes a pin (e.g., the pin EN as shown in the drawing) for receiving the PWM dimming signal, and the LED driver circuit 20 is enabled/disabled in accordance with the PWM dimming signal. When the LED driver circuit 20 is enabled, current flows through the LEDs; when the LED driver circuit 20 is disabled, no current flows through the LEDs. As such, the average value of the current flows through the LEDs (i.e., the average brightness of the LEDs) can be controlled in accordance with the PWM dimming signal. In some LED driver chips or LED driver circuits, a PWM dimming input pin or input node is included, and the PWM dimming signal generated by PWM dimming signal generator 15 can be coupled to the PWM dimming input pin/node in these cases. The PWM dimming signal generator 15 and the LED driver circuit 20 can be integrated into an IC chip or be separated into multiple chips.

Referring to FIG. 19 for an example of the internal circuit of the PWM dimming signal generator, it includes a power-off detection circuit 11a, a counter 201, a DAC 202 (in broad sense, i.e., it can be the mapping table circuit 203), and a duty ratio controller 207. The power-off detection circuit 11a generates a pulse in response to each detected power-off of the AC power switch. The counter 201 counts the number of the pulses and generates a count number Qn. The DAC 202 (or mapping table circuit 203) converts the count number Qn to the reference signal Vref. The duty ratio controller 207 receives a clock OSC, and adjusts the duty ratio of the PWM dimming signal it generates in accordance with the reference signal Vref.

The duty ratio controller 207 can be embodied by various forms. Please refer to FIG. 20 as one example. A transistor Q207, a capacitor C207, and a current source 2072 form a saw tooth signal generator. A comparator 2071 compares the output of the saw tooth signal generator with the reference signal Vref to generate a PWM dimming signal, wherein the pulse width and duty ratio of the PWM dimming signal are controlled by the reference signal Vref.

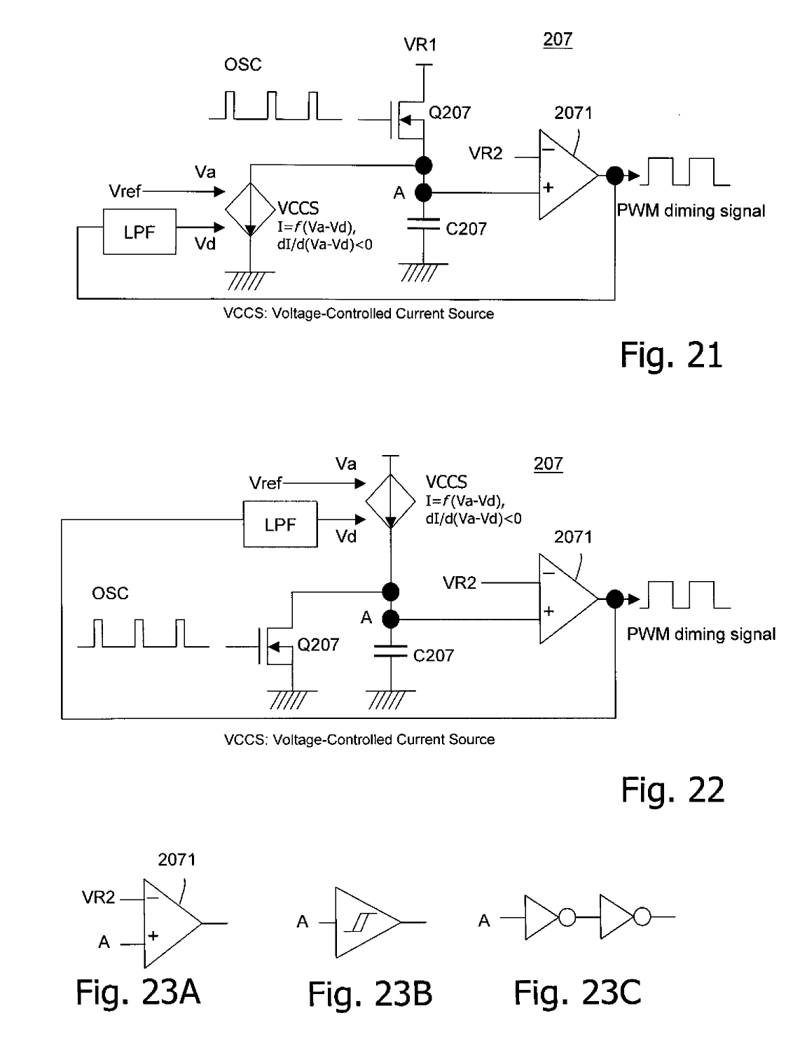

FIGS. 21-22 show two other embodiments of the duty ratio controller 207. These two embodiments provide close-loop adjustment of the current amount of the current source so as to automatically adjust the current amount to an optimum value. In these embodiments, the reference signal Vref is provided for adjusting a slope of the saw tooth signal, not as a reference level to be compared with the saw tooth signal.

More specifically, as shown in the FIGS. 21-22, the current source VCCS is a voltage-controlled current source, whose current is controlled by a difference between voltages Va and Vd (I=f(Va−Vd)). In these two embodiments, as the difference (a signed number) increases, the current amount decreases. (The current source VCCS can also be designed in a way that when the difference increases, the current increases. In this case, it only requires exchanging connections of the voltages Va and Vd.) Similar to the circuit shown in FIG. 20, a saw tooth signal generator is formed by the transistor Q207, the capacitor C207, and the current source VCCS, wherein the slope of the saw tooth signal generated by the saw tooth signal generator is controlled by the difference between the voltages Va and Vd, i.e., controlled by the reference signal Vref. The comparator 2071 compares the output generated by the saw tooth signal generator with a reference signal VR2, and generates a PWM dimming signal according to the result. A low pass filter LPF obtains an average value of the PWM dimming signal, as the voltage Vd, and the reference signal Vref is provided as the voltage Va in the circuit. With a certain value of the reference signal Vref, because of the close loop feedback control, the current amount of the current source VCCS will be automatically adjusted to a corresponding optimum value. When the level of the reference signal Vref is changed, the balanced point of the circuit will be changed, and hence, the pulse width and duty ratio of the PWM dimming signal will be changed accordingly.

In fact, in FIGS. 21-22, it is not necessary to provide the comparator 2071; the comparator 2071 can be replaced by a Smith trigger (a buffer with hysteresis effect), or inverters connected in series, as shown in FIGS. 23A-23C. These circuits can also generate PWM dimming signals with pulse widths and duty ratios controllable by the reference signal Vref.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. The details of each foregoing circuit can be modified in various ways which shall fall within the claim scope of the present invention. As one example, an additional circuit device which does not substantially affect the primary function of the circuit can be interposed between two devices shown to be in direct connection in the embodiments of the present invention. As another example, the LEDs illustrated in the forgoing embodiments, which mean to include white LEDs, color LEDs and organic LEDs, are for example only; the spirit of the present invention is not limited only to the LEDs, but can also be applied to any light emitting devices which are operated by current-control. As yet another example, the signal generator or power-off detection circuit 11a is not limited to generating one pulse in response to each detected power-off of the AC power switch, but it can generate multiple pulses in response to one power-off. In view of the foregoing, the spirit of the present invention should cover all such and other modifications and variations, which should be interpreted to fall within the scope of the following claims and their equivalents.

What is claimed is:

1. An AC power line controlled light emitting device dimming circuit comprising:
a light emitting device driver circuit for controlling current through a light emitting device, wherein the light emitting device is current-controlled; and
a level adjustment circuit for detecting power-off of an AC power switch and generating a corresponding level adjustment signal which is transmitted to the light emitting device driver circuit to control the current through the light emitting device accordingly.

2. The AC power line controlled light emitting device dimming circuit of claim 1, wherein the light emitting device is a white LED, color LED, or organic LED.

3. The AC power line controlled light emitting device dimming circuit of claim 1, wherein the level adjustment circuit includes a signal generator which generates at least one pulse in response to each power-off of the AC power switch.

4. The AC power line controlled light emitting device dimming circuit of claim 3, wherein the light emitting device driver circuit includes:
a counter counting a number of the pulses generated by the signal generator;
a conversion circuit converting the number of the pulses counted by the counter to a reference signal; and
an error amplifier comparing the reference signal with a signal relating to the current through the light emitting device, to provide an output for feedback controlling the current through the light emitting device.

5. The AC power line controlled light emitting device dimming circuit of claim 4, wherein the conversion circuit is a digital to analog converter or a mapping table circuit.

6. The AC power line controlled light emitting device dimming circuit of claim 1, wherein the level adjustment circuit includes a reference signal generator which generates a reference signal according to power-off times of the AC power switch, and the light emitting device driver circuit controls the current through the light emitting device according to the reference signal.

7. The AC power line controlled light emitting device dimming circuit of claim 6, wherein the reference signal generator includes:
a power-off detection circuit for generating at least one pulse in response to each power-off of the AC power switch;
a counter counting a number of the pulses generated by the power-off detection circuit; and
a conversion circuit converting the number of the pulses counted by the counter to a reference signal.

8. The AC power line controlled light emitting device dimming circuit of claim 7, wherein the conversion circuit is a digital to analog converter or a mapping table circuit.

9. The AC power line controlled light emitting device dimming circuit of claim 1, wherein the level adjustment circuit includes a pulse width modulation (PWM) dimming signal generator which generates a PWM dimming signal according to power-off times of the AC power switch, and wherein the light emitting device driver circuit controls the current through the light emitting device according to the PWM diming signal.

10. The AC power line controlled light emitting device dimming circuit of claim 9, wherein the PWM dimming signal generator includes:
a power-off detection circuit for generating at least one pulse in response to each power-off of the AC power switch;
a counter counting a number of the pulses generated by the power-off detection circuit;
a conversion device converting the number of the pulses counted by the counter to a first reference signal; and
a duty ratio controller for generating the PWM dimming signal, wherein the duty ratio controller receives a clock signal and adjusts a duty ratio of the PWM dimming signal according to the first reference signal.

11. The AC power line controlled light emitting device dimming circuit of claim 10, wherein the conversion device is a digital to analog converter (DAC) or a mapping table circuit.

12. The AC power line controlled light emitting device dimming circuit of claim 10, wherein the duty ratio controller includes:
a saw tooth signal generator generating a saw tooth signal; and
a comparator comparing the saw tooth signal with the first reference signal to generate the PWM diming signal.

13. The AC power line controlled light emitting device dimming circuit of claim 10, wherein the duty ratio controller includes:
a saw tooth signal generator generating a saw tooth signal, wherein a slope of the saw tooth signal is controlled by the first reference signal; and
an output circuit converting the saw tooth signal to the PWM diming signal.

14. The AC power line controlled light emitting device dimming circuit of claim 13, wherein the output circuit includes one of the following circuits: a comparator comparing the saw tooth signal with a second reference signal; a hysteresis buffer receiving the saw tooth signal; or a plurality of inverters connected in series, wherein the first stage inverter of the two inverters receives the saw tooth signal.

15. The AC power line controlled light emitting device dimming circuit of claim 13, wherein the duty ratio controller further includes a low pass filter receiving an output of the output circuit to obtain an average value; and wherein the saw tooth signal generator determines the slope of the saw tooth signal according to a difference between the first reference signal and the average value.

16. The AC power line controlled light emitting device dimming circuit of claim 1, wherein the light emitting device and the light emitting device driver circuit are coupled to different capacitors respectively.

17. The AC power line controlled light emitting device dimming circuit of claim 1, further comprising a time-out timer measuring a power-off period of the AC switch, wherein when the power-off period is longer than a predetermined period, the current through the light emitting device is reset to a default value at a next time the AC switch is turned on.

18. A method of dimming an AC power line controlled light emitting device, comprising:
providing a light emitting device, wherein the light emitting device is current-controlled;
detecting power-off of an AC power switch and generating a corresponding level adjustment signal; and
controlling a current through the light emitting device according to the level adjustment signal.

19. The diming method of claim 18, wherein the step of generating the corresponding level adjustment signal includes: generating at least one pulse in response to each power-off of the AC power switch.

20. The diming method of claim 19, wherein the step of generating the corresponding level adjustment signal further includes: counting a number of the pulses; and converting the counted number to a reference signal.

21. The diming method of claim 19, wherein the step of generating the corresponding level adjustment signal further includes:
counting a number of the pulses;
converting the counted number to a reference signal; and
generating a PWM diming signal according to the reference signal.

22. The diming method of claim 18, further comprising:
resetting the current through the light emitting device to a default value when a power-off period of the AC switch is longer than a predetermined period.
